(19) United States
(12) Patent Application Publication
(10) Pub. No.: US 2012/0038246 A1
(43) Pub. Date: Feb. 16, 2012

(54) ULTRASONIC MOTOR

(75) Inventor: Tetsuyuki SAKAMOTO, Hachioji-shi (JP)

(73) Assignee: OLYMPUS CORPORATION, Tokyo (JP)

(21) Appl. No.: 13/181,644

(22) Filed: Jul. 13, 2011

(30) Foreign Application Priority Data
Aug. 10, 2010 (JP) 2010-179611

(51) Int. Cl. H02N 2/12

(52) U.S. Cl. 310/323.16

(57) ABSTRACT

An ultrasonic motor includes a transducer configured to be assembled as one unit by a piezoelectric device, a holding member, and a friction contact member, a hollow rotor configured to contact the friction contact member, the rotor rotating around a shaft in a direction perpendicular to a plane direction of a elliptical vibration generating surface when a driving force is transmitted to the rotor from the friction contact member, a driving force transmitting member configured to be adhesively fixed to the rotor and which rotates together with the rotor, a case member configured to have a positioning groove to position the transducer and configured to house the transducer, and a press member configured to press the transducer housed in the case member toward the rotor. The holding member comes into line contact or point contact with the positioning groove when the case member houses the transducer.

### CROSS-REFERENCE TO RELATED APPLICATIONS

This application is based upon and claims the benefit of priority from prior Japanese Patent Application No. 2010-179611, filed Aug. 10, 2010, the entire contents of which are incorporated herein by reference.

### BACKGROUND OF THE INVENTION

1. Field of the Invention

The present invention relates to a rotary ultrasonic motor used as, for example, an image vibration correcting unit of a digital camera or an actuator of an autofocus (AF) lens or the like.

2. Description of the Related Art

Recently, ultrasonic motors have been attracting attention as new motors that replace electromagnetic motors. The ultrasonic motors use the vibration of a transducer such as a piezoelectric device. As compared with the conventional electromagnetic motors, the ultrasonic motors have the following advantages: low-rotation high torque obtained without any gears, high coercive force, high resolution, a high degree of silence, no generation of magnetic noise, no influence of magnetic noise, etc.

Such an ultrasonic motor has been disclosed in, for example, Jpn. Pat. Appln. KOKAI Publication No. 9-117168. In this ultrasonic motor, a transducer comprises plate-like piezoelectric devices stacked on each other, elastic bodies that vertically catch the piezoelectric devices from both sides, and an abrasion-resistant material which is a driven body affixed to the surface of the elastic bodies provided on the upper side of the piezoelectric devices. The abrasion-resistant material is pressed by a rotor.

In this ultrasonic motor, the plate-like piezoelectric devices are stacked on each other, such that the transducer simultaneously induces a longitudinal vibration and a torsional vibration, and from these two vibrations, generates an elliptical vibration. A driving force generated at this moment from the elliptical vibration generating surfaces of the piezoelectric devices is transmitted to the abrasion-resistant material, and rotates the rotor via the abrasion-resistant material.

In an ultrasonic motor different from the above-mentioned ultrasonic motor, a transducer comprises a piezoelectric device, a holding member which holds the piezoelectric device, and friction contact members arranged in the piezoelectric device. A rotor is in direct contact with the friction contact members. Thus, if a voltage is applied to the piezoelectric device, a longitudinal vibration and a torsional vibration are induced, and an elliptical vibration is generated. This elliptical vibration is directly transmitted to, via the friction contact members, a rotor which is a driven body, and the rotor is driven by friction.

In such an ultrasonic motor, versatility of the ultrasonic motor and stabilization of the characteristics of the ultrasonic motor are attained by packaging primary components as a unit.

The configuration of the above-described ultrasonic motor disclosed in Jpn. Pat. Appln. KOKAI Publication No. 9-117168 may be complicated because the plate-like piezoelectric devices are stacked and the elastic bodies catch the piezoelectric devices.

Moreover, as described above, when the friction contact members are in direct contact with the rotor and the rotor is driven by the friction contact members, the accuracy of the relative positions of the central (rotation) shaft of the rotor and the friction contact members may be decreased by the processing and assembly of the ultrasonic motor.

When the piezoelectric devices are pressed by a pressing member and the friction contact members are thus pressed toward the rotor, the point of application for pressing (a contact point between the pressing member and the piezoelectric device) is displaced by the assembly of the transducer.

As a result, the posture of the transducer is tilted, and the contact surfaces of the rotor and the transducer may be out of equal contact. This may lead to the deterioration of the driving characteristics of the ultrasonic motor.

### BRIEF SUMMARY OF THE INVENTION

The present invention has been made under these circumstances, and is directed to provide an ultrasonic motor having packaged primary components, having a simple configuration, and having stable driving characteristics.

According to an aspect of embodiments, an ultrasonic motor includes a piezoelectric device, the section of the piezoelectric device perpendicular to its central axis having a length ratio of a rectangle, the piezoelectric device inducing a longitudinal vibration and a torsional vibration in response to a voltage, and generating an elliptical vibration from the longitudinal vibration and the torsional vibration, a holding member configured to hold the piezoelectric device at the position of a node of the torsional vibration, a friction contact member configured to be provided in an elliptical vibration generating surface of the piezoelectric device, a transducer configured to be assembled as one unit by the piezoelectric device, the holding member, and the friction contact member, a hollow rotor configured to contact the friction contact member, the rotor rotating around a shaft in a direction perpendicular to a plane direction of the elliptical vibration generating surface when a driving force is transmitted to the rotor from the friction contact member, a driving force transmitting member configured to be adhesively fixed to the rotor and which rotates together with the rotor, a case member configured to have a positioning groove to position the transducer and configured to house the transducer, a press member configured to press the transducer housed in the case member toward the rotor and a rotor support member configured to rotatably support the rotor via the driving force transmitting member, wherein the holding member comes into line contact or point contact with the positioning groove when the case member houses the transducer.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of an ultrasonic motor according to a first embodiment of the present invention;

FIG. 2 is an exploded perspective view of the ultrasonic motor;

FIG. 3 is a front view of the ultrasonic motor;

FIG. 4 is a side view of the ultrasonic motor;

FIG. 5 is a sectional view along the line 5-5 shown in FIG. 3;

FIG. 6 is a sectional view along the line 6-6 shown in FIG. 4;

FIG. 7 is a perspective view of an ultrasonic motor according to a second embodiment of the present invention;

FIG. 8 is an exploded perspective view of the ultrasonic motor;

FIG. 9 is a front view of the ultrasonic motor;

FIG. 10 is a side view of the ultrasonic motor;

FIG. 11 is a sectional view along the line 11-11 shown in FIG. 9;

FIG. 12 is a sectional view along the line 12-12 shown in FIG. 10;

FIG. 13 is a perspective view of a holding member according to a third embodiment of the present invention;

FIG. 14 is a perspective view of a transducer including the holding member shown in FIG. 13;

FIG. 15 is a perspective view of a holding member according to a fourth embodiment of the present invention; and

FIG. 16 is a perspective view of a transducer including the holding member shown in FIG. 15.

### DETAILED DESCRIPTION OF THE INVENTION

Hereinafter, embodiments of the present invention will be described in detail with reference to the drawings.

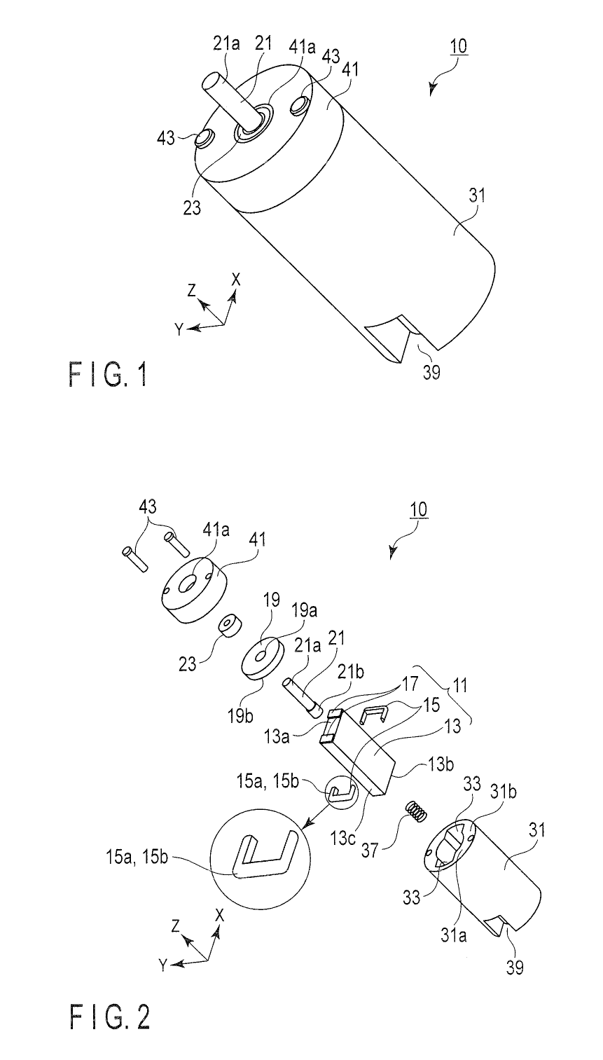

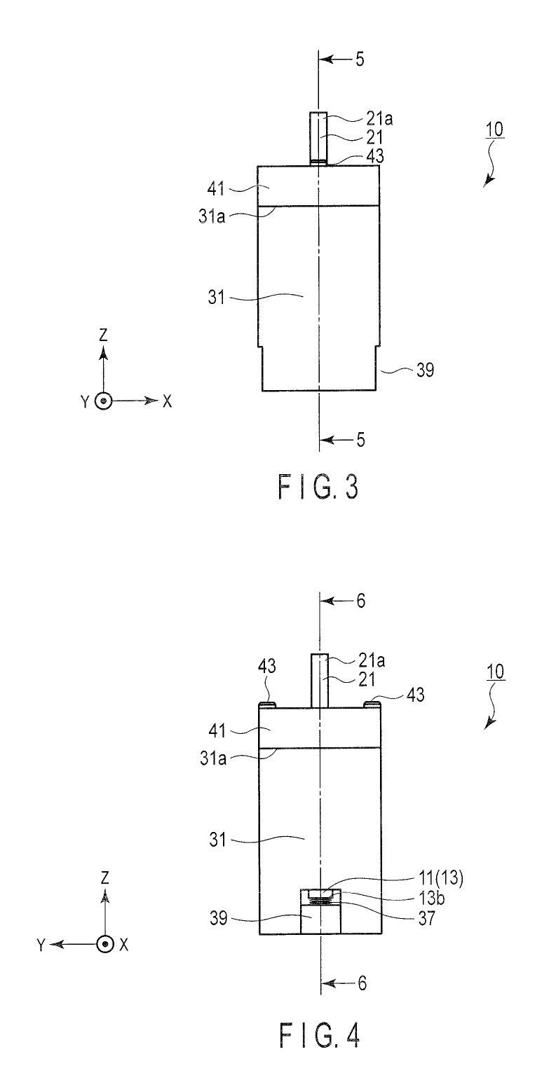

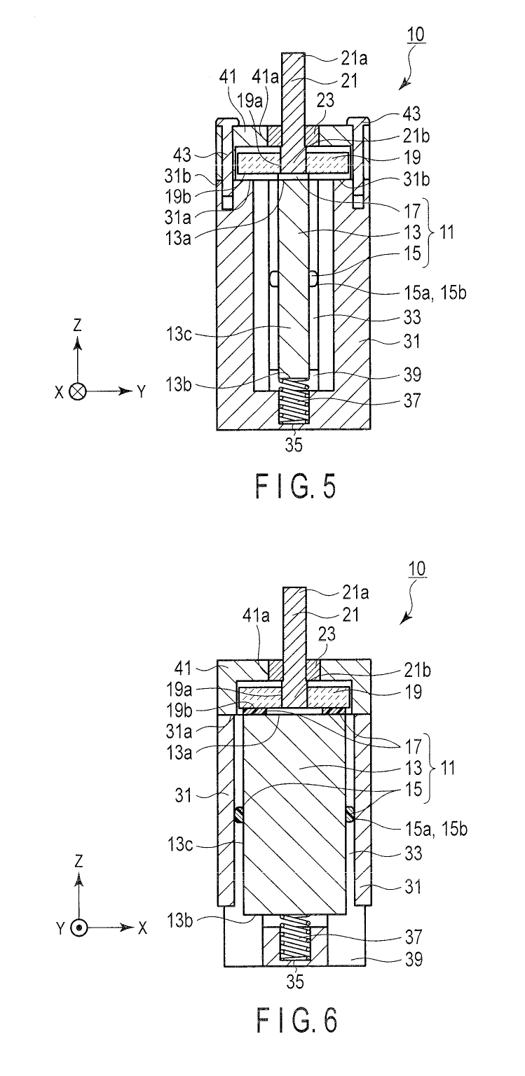

The first embodiment is described with reference to FIG. 1, FIG. 2, FIG. 3, FIG. 4, FIG. 5, and FIG. 6.

From now on, the width directions of a transducer 11 and a piezoelectric device 13 are an X-axis direction, the thickness directions of the transducer 11 and the piezoelectric device 13 perpendicular to the X-axis direction are a Y-axis direction, and the height directions of the transducer 11 and the piezoelectric device 13 perpendicular to the X-axis direction and the Y-axis direction are a Z-axis direction.

An ultrasonic motor 10 has the transducer 11 which is a primary component of the ultrasonic motor 10.

As shown in FIG. 2, the transducer 11 has the piezoelectric device 13, piezoelectric device holding members (hereinafter, holding members 15), and friction contact members 17. In response to a voltage, the piezoelectric device 13 induces a longitudinal vibration that expands and contracts in the direction of the rotation axis of the transducer 11, and a torsional vibration that is generated on the rotation axis of the transducer 11 as a torsion axis. From these two vibrations, the piezoelectric device 13 generates an elliptical vibration. The holding members 15 hold the piezoelectric device 13 at the position of a node of the torsional vibration of the piezoelectric device 13. The friction contact members 17 are arranged in one surface of an elliptical vibration generating surface of the piezoelectric device 13.

As shown in FIG. 2, FIG. 5, and FIG. 6, the section of the piezoelectric device 13 perpendicular to its central axis has a length ratio of a rectangle. An upper surface 13a of the piezoelectric device 13 serves as the elliptical vibration generating surface of the piezoelectric device 13 for generating an elliptical vibration from the longitudinal vibration and the torsional vibration.

As shown in FIG. 2, a first surface of each of the holding members 15 facing a side surface 13c of the piezoelectric device 13 is, for example, Π shaped (depressed) so that the holding member 15 is fitted at the position of the node of the torsional vibration of the piezoelectric device 13. The holding members 15 is fixedly attached to the position of the node by, for example, an adhesive agent. A second surface of the holding member 15 serves as a facing surface 15a of the holding member 15 that faces a later-described positioning groove 33 when a later-described case member 31 houses the transducer 11 and the holding member 15 is disposed in the positioning groove 33. The second surface of the holding member 15 has a semicircular curved surface.

Two friction contact members 17 are arranged in the elliptical vibration generating surface, and are fixedly attached thereto by, for example, an adhesive agent.

As shown in FIG. 2, the holding member 15 and the friction contact members 17 are fixedly attached to the piezoelectric device 13 as described above, so that the transducer 11 is assembled as one unit by the piezoelectric device 13, the holding members 15, and the friction contact members 17. The transducer 11 assembled as one unit is packaged (enveloped) by the later-described case member 31.

The friction contact members 17 are in contact with a rotor 19 which is a driven body, and transmit, to the rotor 19, a driving force to rotate the rotor 19. That is, the rotor 19 as a driven body, which is driven (rotated) by the elliptical vibration that is its driving (rotation) force transmitted from the friction contact members 17, is in contact with the friction contact members 17.

As described above, the rotor 19 contacts the friction contact members 17 and a contact surface 19b, and when the driving force is transmitted to the rotor 19 from the friction contact members 17, the rotor 19 rotates around a center (rotation) shaft in a direction (Z-axis direction) perpendicular to a plane direction of the elliptical vibration generating surface. The rotor 19 has a hollow circular shape having an opening 19a.

As shown in FIG. 5 and FIG. 6, a proximal end 21b of a transmission shaft 21 which is a central (rotation) shaft of the rotor 19 is adhesively fixed to the opening 19a of the rotor 19. Therefore, when the rotor 19 rotates, the transmission shaft 21 rotates together with the rotor 19. The transmission shaft 21 is connected to an unshown member at a distal end 21a, and transmits a driving force to the unshown member and drives the unshown member. Thus, the transmission shaft 21 is a driving force transmitting member for transmitting the driving force to the unshown member.

As shown in FIG. 5 and FIG. 6, the transmission shaft 21 is fitted in an inner ring of a transmission shaft bearing 23 such as a bearing between the distal end 21a and the proximal end 21b. The distal end 21a of the transmission shaft 21 passes through the inner ring of the transmission shaft bearing 23 to be connected to the unshown member. When the transmission shaft bearing 23 is a bearing, the transmission shaft bearing 23 is driven (rotated) together with the transmission shaft 21. The transmission shaft bearing 23 may be a slide bearing that uses, for example, a highly slidable resin.

As shown in FIG. 2, FIG. 5, and FIG. 6, the piezoelectric device 13 and the holding members 15 are housed in the cylindrical case member 31. That is, as described above, the case member 31 packages (envelopes/houses) the transducer 11 assembled as one unit (the piezoelectric device 13 and the holding members 15).

As shown in FIG. 2, FIG. 5, and FIG. 6, the case member 31 has the positioning grooves 33 for positioning the transducer 11. The positioning groove 33 is Π shaped (depressed). The positioning groove 33 is a long groove which is provided along the longitudinal axis direction of the case member 31 and in which the holding member 15 is slidable. The positioning grooves 33 are disposed at two positions corresponding to the holding members 15. The holding members 15 slide in the positioning grooves 33 under the guidance of the positioning grooves 33 and are thus positioned. As a result, the transducer 11 including the piezoelectric device 13 is positioned in the X-axis direction and the Y-axis direction, and the transducer 11 is enveloped in the case member 31 in a positioned state. That is, the case member 31 positions and holds the piezoelectric device 13 (transducer 11) via the holding members 15 and the positioning grooves 33 in the X-axis direction and the Y-axis direction.

In the present embodiment, as described above, the facing surface 15a of the holding member 15 that faces the positioning groove 33 has a curved surface. When the case member 31 houses the transducer 11 and the holding members 15 are disposed in the positioning grooves 33, the facing surfaces 15a come into line contact with the positioning groove 33 so that the transducer 11 tilts around the X-axis and the Y-axis. That is, the holding member 15 has, in its facing surface 15a that faces the positioning groove 33, a curved surface portion 15b that comes into line contact with the positioning groove 33.

Accordingly, the transducer 11 can be tilted around the X-axis and the Y-axis by the curved surface portion 15b (facing surface 15a) of the holding member 15 so that the friction contact members 17 come into contact with the rotor 19 and follow the contact surface 19b of the rotor 19 when the transducer 11 is positioned in the X-axis direction and the Y-axis direction by the holding members 15 and the positioning grooves 33. In other words, the case member 31 positions and holds the piezoelectric device 13 via the holding members 15 so that the height direction of the transducer 11 can tilt relative to the central axis direction of the case member 31.

As shown in FIG. 5 and FIG. 6, the case member 31 has a Π shaped (depressed) groove 35 at the bottom. The groove 35 is provided with a press member 37 which contacts a bottom surface 13b of the piezoelectric device 13 housed in the case member 31 and which presses the friction contact members 17 (transducer 11) toward the rotor 19 via the piezoelectric device 13. The press member 37 is, for example, a coil spring or a leaf spring.

The case member 31 also has a cut-out 39 on the bottom side. An unshown flexible member for applying a voltage to the piezoelectric device 13 is inserted through the cut-out 39. The flexible member extends outward from the case member 31.

As shown in FIG. 1, FIG. 2, FIG. 3, FIG. 4, FIG. 5, and FIG. 6, a rotor support member 41 having a substantially cylindrical shape is provided in an upper surface 31a of the case member 31. The rotor support member 41 rotatably supports the rotor 19 via the transmission shaft bearing 23 and the transmission shaft 21 so that the rotor 19 is rotatable. The rotor support member 41 is also a bearing support member having an opening 41a which holds the transmission shaft bearing 23 so that the transmission shaft bearing 23 can be driven (rotated) and which fixes the transmission shaft bearing 23 in a fitted state and which supports the transmission shaft bearing 23.

The rotor support member 41 serves as a lid for covering the rotor 19. The rotor support member 41 also positions the rotor 19 in the X-axis direction and the Y-axis direction via the transmission shaft bearing 23. The distal end 21a of the transmission shaft 21 protrudes from the rotor support member 41 (opening 41a).

The outer shape of the rotor support member 41 is about the same as the outer shape of the case member 31. The rotor support member 41 is set to the case member 31 by, for example, a jig so that the outer surface of the rotor support member 41 is flush with the outer surface of the case member 31, thereby aligning the central axis of the transmission shaft 21 with the central axis of the transducer 11.

As shown in FIG. 5, the rotor support member 41 is fastened to an edge 31b of the upper surface 31a of the case member 31 by fastening members 43 such as screws. When the rotor support member 41 is fastened to the edge 31b by the fastening members 43 and covers the rotor 19, the above-mentioned press member 37 bends in a desired amount, thereby generating a press force. As a result, the piezoelectric device 13 is pressed along the positioning grooves 33 via the holding members 15, and the friction contact members 17 are pressed against the rotor 19.

The rotor 19 is pressed against the friction contact members 17 as described above by pressurization when the fastening members 43 fasten the rotor support member 41 to the edge 31b of the upper surface 31a of the case member 31 and by a press force of the press member 37. Accordingly, the transducer 11 can be tilted around the X-axis and the Y-axis by the curved surface portion 15b (facing surface 15a) of the holding member 15 so that the friction contact members 17 follow the contact surface 19b of the rotor 19 when the transducer 11 is positioned in the X-axis direction and the Y-axis direction by the holding members 15 and the positioning grooves 33 as described above.

Now, a method of assembling the ultrasonic motor 10 in the present embodiment is described.

The press member 37 is provided in the groove 35.

The holding members 15 are fixedly attached to the position of the node of the torsional vibration of the piezoelectric device 13 by, for example, an adhesive agent. The friction contact members 17 are fixedly attached to the elliptical vibration generating surface (upper surface 13a) by, for example, an adhesive agent. As a result, the transducer 11 is assembled as one unit. The transducer 11 then slides in the positioning grooves 33 via the holding members 15 and is thus positioned, such that the transducer 11 is positioned in the X-axis direction and the Y-axis direction, and the transducer 11 is packaged (enveloped) by the case member 31 in a positioned state.

At the same time, the press member 37 contacts the bottom surface 13b of the piezoelectric device 13.

Furthermore, the rotor 19 to which the transmission shaft 21 is adhesively fixed is mounted on the friction contact members 17. The distal end 21a then passes through the inner ring of the transmission shaft bearing 23, and the transmission shaft bearing 23 is disposed in the opening 41a. The rotor support member 41 holds the transmission shaft bearing 23 so that the transmission shaft bearing 23 can be driven (rotated). The rotor support member 41 also covers the rotor 19, and positions the rotor 19 in the X-axis direction and the Y-axis direction via the transmission shaft bearing 23. Moreover, the rotor support member 41 is fastened to the edge 31b of the upper surface 31a of the case member 31 by the fastening members 43. At the same time, the press member 37 presses the friction contact members 17 toward the rotor 19 via the piezoelectric device 13.

When the ultrasonic motor 10 is assembled, for example, when the rotor 19 is mounted on the friction contact members 17, the position of the transmission shaft 21 which is the central (rotation) shaft of the rotor 19 may be displaced relative to the positions of the friction contact members 17 as a result of the processing of the components of the ultrasonic motor 10 and the assembly of the ultrasonic motor 10.

Moreover, after the transducer 11 is assembled, the point of application for pressing (the contact point between the press member 37 and the bottom surface 13b) may be displaced by the assembly of the transducer 11 when the piezoelectric device 13 is pressed by the press member 37 and the friction contact members 17 are pressed toward the rotor 19.

However, in the present embodiment, the friction contact members 17 are brought into contact with the rotor 19 by pressurization when the fastening members 43 fasten the rotor support member 41 to the edge 31b of the upper surface 31a of the case member 31 and by a press force of the press member 37 as described above when the transducer 11 is positioned in the X-axis direction and the Y-axis direction by the holding members 15 and the positioning grooves 33. Accordingly, the transducer 11 can be tilted around the X-axis and the Y-axis by the curved surface portion 15b (facing surface 15a) of the holding member 15 so that the friction contact members 17 follow the contact surface 19b of the rotor 19. Thus, the friction contact members 17 are pressed against the rotor 19 by the pressurization of the fastening members 43 and by the press force of the press member 37, and the fastening members 43 fasten the rotor support member 41 to the edge 31b, such that the friction contact members 17 always uniformly contact the contact surface 19b of the rotor 19.

As described above, in the present embodiment, the fastening members 43 are pressurized from the side of the rotor 19 to the side of the transducer 11, such that the transducer 11 is tilted around the X-axis and the Y-axis by the curved surface portion 15b (facing surface 15a), and the friction contact members 17 always uniformly contact the contact surface 19b.

As the rotor 19 is positioned in the X-axis direction and the Y-axis direction by the rotor support member 41 via the transmission shaft bearing 23, the friction contact members 17 always uniformly contact the contact surface 19b owing to the transducer 11 that tilts around the X-axis and the Y-axis.

The displacement of the contact point between the press member 37 and the bottom surface 13b is prevented because the press member 37 is disposed in the groove 35 and because the transducer 11 is positioned in the X-axis direction and the Y-axis direction by the holding members 15 and the positioning grooves 33 as described above.

When a voltage is applied to the piezoelectric device 13 via the flexible member, the piezoelectric device 13 induces a longitudinal vibration and a torsional vibration, and from these two vibrations, generates an elliptical vibration. A driving force is transmitted to the transmission shaft 21 from the elliptical vibration generating surface of the piezoelectric device 13 via the friction contact members 17 and the rotor 19, and the transmission shaft 21 rotates. In this case, as the friction contact members 17 always uniformly contact the contact surface 19b of the rotor 19, stable driving characteristics can be obtained.

The transmission shaft 21 then drives the unshown member.

As described above, in the present embodiment, the transducer 11 can be assembled as one unit, and the transducer 11 can be packaged by the case member 31, thereby allowing the transducer 11 and the ultrasonic motor 10 to be simpler in configuration.

Furthermore, in the present embodiment, even if the position of the transmission shaft 21 which is the central (rotation) shaft of the rotor 19 is displaced relative to the positions of the friction contact members 17 as a result of the processing of the components of the ultrasonic motor 10 and the assembly of the ultrasonic motor 10, the transducer 11 can be positioned in the X-axis direction and the Y-axis direction by the holding members 15 and the positioning grooves 33, and the positioned transducer 11 can be tilted around the X-axis and the Y-axis by the curved surface portion 15b. Thus, in the present embodiment, as the friction contact members 17 can always uniformly contact the contact surface 19b of the rotor 19, stable driving characteristics can be obtained.

Still further, in the present embodiment, the press member 37 can be disposed in the groove 35, and the transducer 11 is positioned in the X-axis direction and the Y-axis direction as described above. Thus, after the transducer 11 is assembled, the point of application for pressing (the contact point between the press member 37 and the bottom surface 13b) is not displaced by the assembly of the transducer, so that the displacement of the point of application can be prevented.

Moreover, in the present embodiment, the curved surface portion 15b in the facing surface 15a of the holding member 15 comes into line contact with the positioning groove 33. Therefore, even if the transmission shaft 21 which is the central (rotation) shaft of the rotor 19 is displaced relative to the surface of the holding member 15, the friction contact members 17 can always uniformly contact the contact surface 19b of the rotor 19 in a more stable condition, so that stable driving characteristics can be obtained.

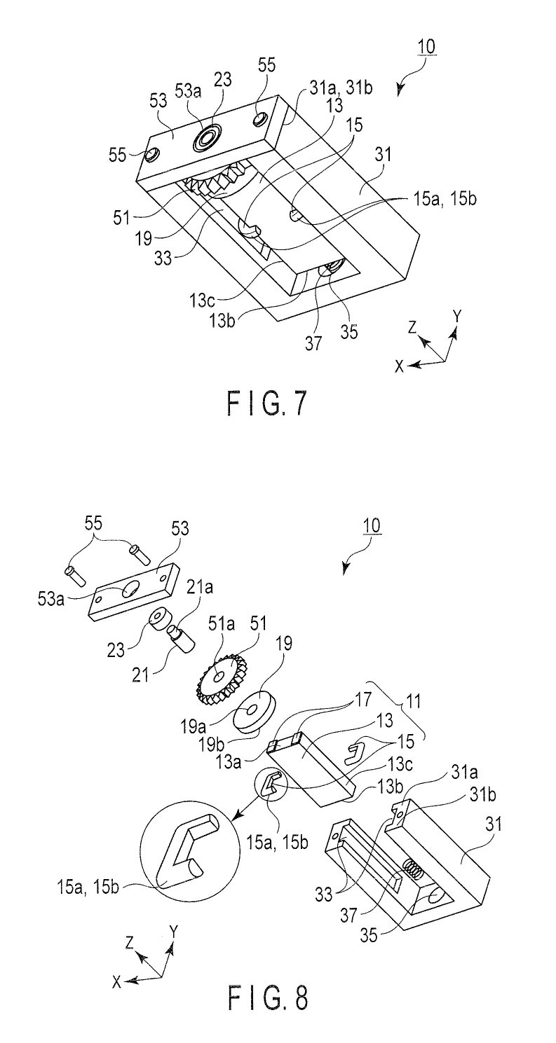

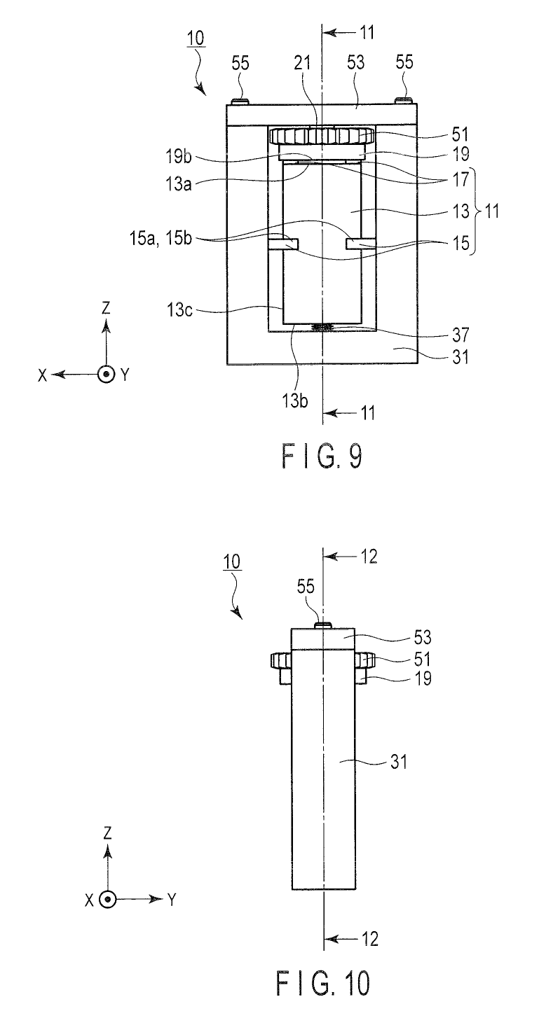

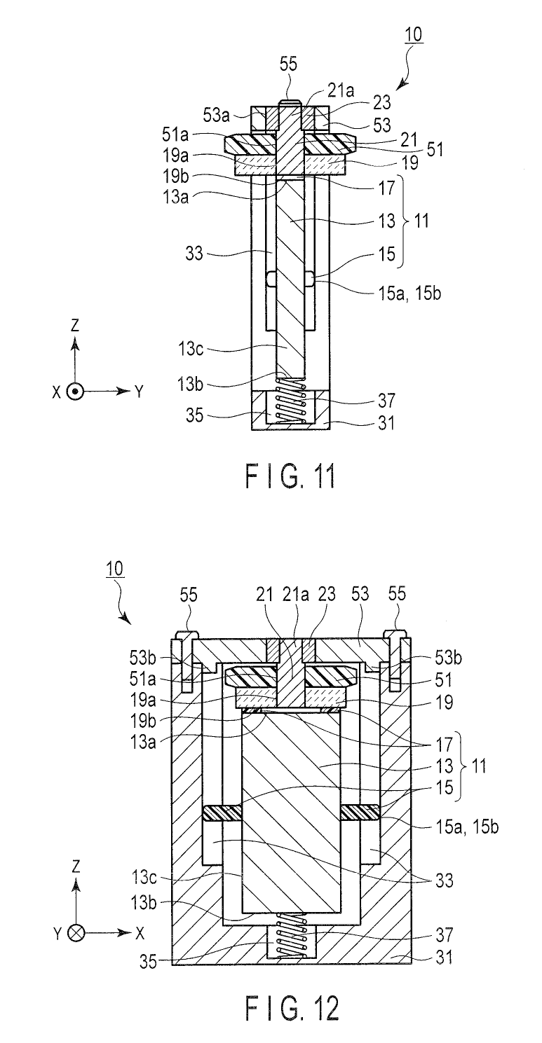

Now, the second embodiment according to the present invention is described with reference to FIG. 7, FIG. 8, FIG. 9, FIG. 10, FIG. 11, and FIG. 12. The same components as those in the first embodiment are provided with the same reference marks as those in the first embodiment and are thus not described.

As shown in FIG. 9, FIG. 10, FIG. 11, and FIG. 12, a case member 31 in the present embodiment is substantially Π shaped (depressed) to catch a piezoelectric device 13 from the sides of a bottom surface 13b and a side surface 13c of the piezoelectric device 13 in order to house a transducer 11.

A rotation force transmission gear 51 toothed with an unshown external device on the side surface of the case member 31 is mounted on a rotor 19. As shown in FIG. 8, the rotation force transmission gear 51 has an opening 51a which a transmission shaft 21 is fitted in and passed through. This rotation force transmission gear 51 rotates when a driving force (turning force) is transmitted thereto from the transmission shaft 21 via friction contact members 17 and the rotor 19. The rotation force transmission gear 51 transmits this driving force to the unshown external device, and drives the device. The rotation force transmission gear 51 is disposed in the rotor 19 coaxially with the rotor 19 by passing the transmission shaft 21 through the opening 51a.

The transmission shaft 21 that passes through an opening 19a is adhesively fixed to the rotation force transmission gear 51 in its surface contacting the rotation force transmission gear 51. The transmission shaft 21 in the present embodiment is a driving force transmitting member for transmitting the driving force to the unshown external device via the rotation force transmission gear 51.

As shown in FIG. 11 and FIG. 12, a distal end 21a of the transmission shaft 21 is fitted in an inner ring of a transmission shaft bearing 23 such as a bearing. The transmission shaft bearing 23 may be a slide bearing that uses, for example, a highly slidable resin.

A bearing support member 53 having a substantially planar shape is provided in an upper surface 31a of the case member 31. The bearing support member 53 has an opening 53a which holds the transmission shaft bearing 23 so that the transmission shaft bearing 23 can be driven (rotated) and which fixes the transmission shaft bearing 23 in a fitted state and which supports the transmission shaft bearing 23. The bearing support member 53 is also a rotation force transmission gear support member which supports the rotation force transmission gear 51 via the transmission shaft bearing 23 and the transmission shaft 21 so that the rotation force transmission gear 51 can be rotated. The bearing support member 53 is also a rotor support member which rotatably supports the rotor 19 via the transmission shaft bearing 23 and the transmission shaft 21 so that the rotor 19 can be rotated.

The bearing support member 53 has positioning protrusions 53b. The protrusions 53b position the transmission shaft bearing 23 and the transmission shaft 21 which is a central (rotation) shaft of the rotor 19 so that the transmission shaft 21 which is the central (rotation) shaft of the rotor 19 is aligned with the central axis of the transducer 11 by fitting the protrusions 53b in the positioning grooves 33 when the bearing support member 53 is disposed in the upper surface 31a of the case member 31. Two protrusions 53b are provided to correspond to the positioning grooves 33.

The bearing support member 53 has a thickness and a width that are substantially similar to the thickness and width of the case member 31.

The bearing support member 53 is fastened to an edge 31b of the upper surface 31a of the case member 31 by fastening members 55 such as screws when the protrusions 53b are fitted in the positioning grooves 33.

A method of assembling the ultrasonic motor 10 in the present embodiment is substantially similar to that in the first embodiment, and is therefore not described in detail. The difference between the methods in the first and second embodiments is summarized below.

In the present embodiment, the protrusions 53b are fitted in the positioning grooves 33, such that the transmission shaft bearing 23 and the transmission shaft 21 which is the central (rotation) shaft of the rotor 19 can be quickly positioned, thus the transmission shaft 21 is quickly aligned with the central axis of the transducer 11.

When a voltage is applied to the piezoelectric device 13 via the flexible member, the piezoelectric device 13 induces a longitudinal vibration and a torsional vibration, and from these two vibrations, generates an elliptical vibration. In the present embodiment, in contrast with the first embodiment, driving force is transmitted to the rotation force transmission gear 51 from an elliptical vibration generating surface of the piezoelectric device 13 via the friction contact members 17, the rotor 19, and the transmission shaft 21, thereby rotating the rotation force transmission gear 51. In this case, as the friction contact members 17 always uniformly contact a contact surface 19b of the rotor 19, stable driving characteristics can be obtained. This rotation force is then transmitted to the unshown device from the side surface of the case member 31 through the rotation force transmission gear 51, and drives the device.

Thus, in the present embodiment, advantages similar to those in the first embodiment can be obtained.

Furthermore, in the present embodiment, as the driving force can be externally transmitted from the side surface of the case member 31 by the rotation force transmission gear 51, the ultrasonic motor 10 can be reduced in thickness.

Still further, in the present embodiment, the transmission shaft bearing 23 and the transmission shaft 21 which is the central (rotation) shaft of the rotor 19 can be quickly positioned by the protrusions 53b, thus the transmission shaft 21 can be quickly aligned with the central axis of the transducer 11.

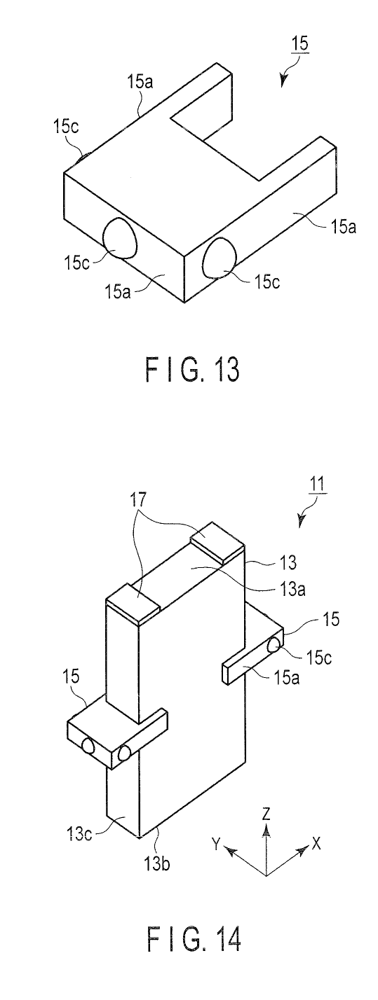

Now, the third embodiment according to the present invention is described with reference to FIG. 13 and FIG. 14. The same components as those in the first and second embodiments are provided with the same reference marks as those in the first and second embodiments and are thus not described.

A holding member 15 in the present embodiment may be Π shaped (depressed). In this case, the holding member 15 may have, in each facing surface 15a that faces positioning grooves 33, a semispherical protrusion 15c that comes into point contact with the positioning groove 33.

In the present embodiment, the protrusion 15c comes into point contact with the positioning groove 33. Therefore, even if a transmission shaft 21 which is a central (rotation) shaft of a rotor 19 is displaced relative to friction contact members 17, the friction contact members 17 are brought into contact with the rotor 19 by pressurization when fastening members 43 fasten a rotor support member 41 to an edge 31b of an upper surface 31a of a case member 31 and by a press force of a press member 37 so that a transducer 11 is positioned in the X-axis direction and the Y-axis direction by the holding members 15 and the positioning grooves 33. Accordingly, the transducer 11 can be easily tilted around the X-axis and the Y-axis by a curved surface portion 15b (facing surface 15a) of the holding member 15 so that the friction contact members 17 follow a contact surface 19b of the rotor 19. Thus, in the present embodiment, the friction contact members 17 can always uniformly contact the contact surface 19b of the rotor 19 in a more stable condition, so that stable driving characteristics can be obtained.

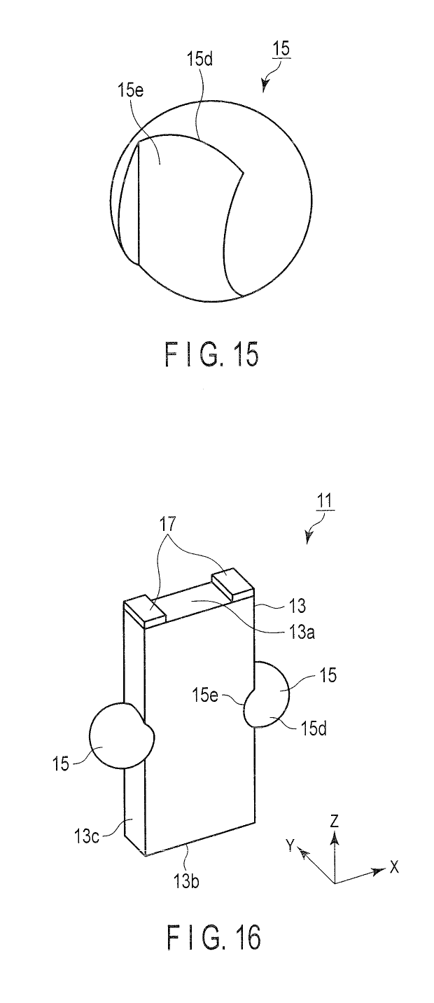

Now, the fourth embodiment according to the present invention is described with reference to FIG. 15 and FIG. 16. The same components as those in the first and second embodiments are provided with the same reference marks as those in the first and second embodiments and are thus not described.

The contact points of a holding member 15 that contact a positioning groove 33 in the present embodiment are provided in the same plane of the holding member 15. Therefore, the holding member 15 is substantially entirely spherical to be in point contact with the positioning groove 33. A portion 15d of the holding member 15 may have a cut-out 15e which is fitted and adhesively fixed at the position of a node of the torsional vibration of a piezoelectric device 13.

In the present embodiment, advantages similar to those in the first to third embodiments can be obtained.

It should be rioted that the contents of the third and fourth embodiments can be incorporated in the first and second embodiments.

Although the fastening members 43 are pressurized from the side of the rotor 19 to the side of the transducer 11 in the embodiments described above, the pressurization does not have to be limited to this form. As long as the transducer 11 can be tilted around the X-axis and the Y-axis by the curved surface portion 15b (facing surface 15a) so that the friction contact members 17 always uniformly contact the contact surface 19b, the pressurization may be directed from the side of the transducer 11 to the side of the rotor 19.

The present invention is not completely limited to the embodiments described above, and the components can be modified at the stage of carrying out the invention without departing from the spirit thereof. Moreover, various inventions can be made by a proper combination of the components disclosed in the embodiments described above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An ultrasonic motor comprising:
a piezoelectric device, the section of the piezoelectric device perpendicular to its central axis having a length ratio of a rectangle, the piezoelectric device inducing a longitudinal vibration and a torsional vibration in response to a voltage, and generating an elliptical vibration from the longitudinal vibration and the torsional vibration;
a holding member configured to hold the piezoelectric device at the position of a node of the torsional vibration;
a friction contact member configured to be provided in an elliptical vibration generating surface of the piezoelectric device;
a transducer configured to be assembled as one unit by the piezoelectric device, the holding member, and the friction contact member;
a hollow rotor configured to contact the friction contact member, the rotor rotating around a shaft in a direction perpendicular to a plane direction of the elliptical vibration generating surface when a driving force is transmitted to the rotor from the friction contact member;
a driving force transmitting member configured to be adhesively fixed to the rotor and which rotates together with the rotor;
a case member configured to have a positioning groove to position the transducer and configured to house the transducer;
a press member configured to press the transducer housed in the case member toward the rotor; and
a rotor support member configured to rotatably support the rotor via the driving force transmitting member,
wherein the holding member comes into line contact or point contact with the positioning groove when the case member houses the transducer.

2. The ultrasonic motor according to claim 1, wherein the holding member includes, in its facing surface that faces the positioning groove, a curved surface portion that comes into line contact with the positioning groove.

3. The ultrasonic motor according to claim 1, wherein the holding member includes, in its facing surface that faces the positioning groove, a semispherical protrusion that comes into point contact with the positioning groove.

4. The ultrasonic motor according to claim 1, wherein contact points of the holding member that contact the positioning groove are provided in the same plane of the holding member.
